(19) United States
(12) Patent Application Publication
(10) Pub. No.: US 2026/0290833 A1
(43) Pub. Date: Sep. 24, 2026

(54) CONDUCTIVE CARBON BLACK, POSITIVE ELECTRODE PLATE, ELECTROCHEMICAL APPARATUS, AND ELECTRONIC APPARATUS

(71) Applicant: Ningde Amperex Technology Limited, Ningde (CN)

(72) Inventor: Xiaoqian LIU, Ningde (CN)

(73) Assignee: Ningde Amperex Technology Limited, Ningde (CN)

(21) Appl. No.: 19/567,401

(22) Filed: Mar. 16, 2026

(30) Foreign Application Priority Data
Mar. 18, 2025 (CN) 202510321988.X

(51) Int. Cl. H01M 4/62; H01M 4/02; H01M 10/0525; H01M 50/411; H01M 50/443

(52) U.S. Cl. CPC H01M 4/625; H01M 50/411; H01M 50/443; H01M 2004/021; H01M 2004/028; H01M 10/0525

(57) ABSTRACT

A conductive carbon black includes a plurality of carbon black units and pores located between adjacent carbon black units, where the carbon black unit includes holes; a bulk density of the conductive carbon black is 0.05 g/cm³-0.1 g/cm³; and a pore volume of the hole is 0.05 cm³/g-0.5 cm³/g. The conductive carbon black in some embodiments of this application has good electrolyte retention, thereby increasing an electrolyte retention rate of the positive electrode plate and further improving the performance of the electrochemical apparatus.

### CROSS-REFERENCE TO RELATED APPLICATION

The present application claims priority to Chinese Patent Application No. 202510321988.X, filed on Mar. 18, 2025, the disclosure of which is hereby incorporated by reference in its entirety.

### TECHNICAL FIELD

This application relates to the field of batteries, and in particular, to a conductive carbon black, a positive electrode plate, an electrochemical apparatus, and an electronic apparatus.

### BACKGROUND

In the energy sector at present, lithium-ion batteries, with their advantages such as high energy density and long cycle life, are widely used in various fields including mobile electronic devices, electric vehicles, and energy storage systems. With continuous technological advancements and sustained growth in market demand, the requirements for lithium-ion battery performance are becoming increasingly stringent.

In positive electrode materials for lithium-ion batteries, conductive carbon black, as a commonly used conductive additive, can construct an effective conductive network between positive electrode active material particles. However, the existing conductive carbon black currently suffers from significant deficiencies in electrolyte retention, which limits its conductivity.

### SUMMARY

Some embodiments of this application provide a conductive carbon black, a positive electrode plate, an electrochemical apparatus, and an electronic apparatus. The conductive carbon black of this application has good electrolyte retention, thereby increasing an electrolyte retention rate of the positive electrode plate and further improving the performance of the electrochemical apparatus.

According to a first aspect, an embodiment of this application provides a conductive carbon black, where the conductive carbon black includes a plurality of carbon black units and pores located between adjacent carbon black units; the carbon black unit includes holes; a bulk density of the conductive carbon black is 0.05 g/cm³-0.1 g/cm³; and a pore volume of the hole is 0.05 cm³/g-0.5 cm³/g.

In this application, the conductive carbon black includes the plurality of carbon black units and the pores located between adjacent carbon black units; and the carbon black unit includes the holes. The bulk density of the conductive carbon black and the pore volume of the hole are adjusted, so that the bulk density of the conductive carbon black is 0.05 g/cm³-0.1 g/cm³, and the pore volume of the hole is 0.05 cm³/g-0.5 cm³/g, allowing the conductive carbon black to form a more efficient conductive network in an electrode of a battery. The carbon black unit in this application refers to a single sphere that constitutes branched carbon black. The bulk density can make carbon black particles be in contact with each other more closely. The pore volume provides more channels for electron transport, facilitating rapid electron migration, reducing the internal resistance of the battery, and improving the charge and discharge efficiency of the battery. The two synergistically accelerate the electron conduction rate of an electrode material, making the performance of the battery more stable during high-current charge and discharge. Furthermore, more storage and transport channels are provided for an electrolyte, allowing the electrolyte to better infiltrate into the electrode material. As an additive of the electrode material, the pores of the conductive carbon black may be in communication with pores of the electrode, forming a more unobstructed electrolyte transport network, thereby improving the infiltration effect of the electrolyte on the electrode. When the bulk density is too small, a contact area between conductive carbon black particles is too small, which in turn deteriorates the conductive network. When the bulk density is too large, the electrolyte retention of the electrode plate is too high, which leads to a reduction in the electrolyte in electrode plate gaps and an anode electrode, and in turn reduces the cycling performance. When the pore volume is too large, the conductive carbon black easily adsorbs the binder, weakening the dispersion effect of the binder in the system, and the conductive carbon black is prone to agglomeration in the electrode plate, affecting the conductive network, thus reducing the rate performance of the battery. Moreover, an excessively large pore volume causes excessive electrolyte to be stored inside the conductive carbon black, leading to a lack of electrolyte at other positions, thus affecting the cycling performance of the battery.

In some specific embodiments, the bulk density of the conductive carbon black is 0.06 g/cm³-0.08 g/cm³, and/or the pore volume of the hole is 0.15 cm³/g-0.3 cm³/g.

In the above specific embodiments, the conductive carbon black can further improve the infiltration effect of the electrolyte on the electrode, and improve the high-temperature performance and cycling retention rate of the battery.

In some specific embodiments, an equivalent diameter of the hole is 10 nm-45 nm.

In the above specific embodiments, when the equivalent diameter of the hole is 10 nm-45 nm, the electrolyte can enter and exit more easily, increasing an electrolyte retention amount of an electrode plate. In the later stage of cycling, the electrolyte can exude to provide ion pathways, which helps to form a more stable electrode-electrolyte interface on the electrode surface. Furthermore, this allows the electrolyte to be in full contact with the electrode material, forming a uniform interface layer, and reducing stress at the interface and uneven electric field distribution, thereby reducing the interface resistance and improving the cycling stability and service life of the battery.

In some specific embodiments, the equivalent diameter of the hole is 15 nm-30 nm.

In the above technical solution, when the equivalent diameter of the hole is 15 nm-30 nm, the electrolyte can enter and exit more smoothly and efficiently. On the one hand, compared to slightly larger holes, better constraint can be provided on the electrolyte, which can significantly increase the electrolyte retention amount of the electrode plate, ensuring that there is always sufficient electrolyte to support the electrode reaction during cycling of the battery. On the other hand, in the later stage of cycling, the electrolyte can stably exude, providing precise and efficient pathways for ion migration, greatly ensuring the continuous progress of the electrode reaction and maintaining the stability of the performance of the battery. In addition, this allows the electrolyte to achieve more sufficient and precise contact with the electrode material, further improving the stability of the electrode-electrolyte interface. When the equivalent diameter of the hole is too small, the capillary action is high, which is not conducive to the exudation of electrolyte in the later stage. When the equivalent diameter of the hole is too large, the uniform distribution of electrolyte on the surface of the conductive carbon black is not facilitated, thus affecting an ion transport path.

In some specific embodiments, the equivalent diameter of the hole is A (nm), the pore volume of the hole is B (cm³/g), and the conductive carbon black satisfies: 100≤A/B≤300.

In the above specific embodiments, the conductive carbon black satisfying 100≤A/B≤300 allows the equivalent diameter of the hole and the pore volume to cooperate with each other, ensuring that ions have sufficiently large channels to pass through smoothly, and providing the sufficient pore volume to store and buffer ions. In a lithium-ion battery, lithium ions can be rapidly and stably transported between an electrode and an electrolyte during charging and discharging, improving the cycling performance and rate performance of the battery. In addition, optimization of the distribution of reaction sites on the electrode surface is facilitated. A specific surface area of an electrode-electrolyte interface is increased, making the electrode reaction more complete and accelerating the electrode reaction kinetic process, thereby improving the overall performance of the battery and increasing the charging and discharging speed and energy conversion efficiency of the battery.

In some specific embodiments, the conductive carbon black satisfies: 100≤A/B≤200.

In the above specific embodiments, the conductive carbon black satisfying 100≤A/B≤200 helps to optimize the structure of the electrode material, allowing the electrode to accommodate more active materials and ensuring good conductivity and ion transport performance, thereby increasing the energy density of the battery and extending the range or operating time of the battery.

In some specific embodiments, the conductive carbon black satisfies at least one of the following: (1) an oil absorption value of the conductive carbon black is 300 mL/100 g-450 mL/100 g; (2) ID/IG of the conductive carbon black is 0.8-1.3; (3) a thermal conductivity of the conductive carbon black is 0.1 W/(m·K)-0.5 W/(m·K); or (4) the conductive carbon black includes a branched structure formed by stacking the plurality of carbon black units.

In the above specific embodiments, when the oil absorption value of the conductive carbon black is 300 mL/100 g-450 mL/100 g, the electrolyte is adsorbed on the surface and in the pores of the conductive carbon black, making the contact between the conductive carbon black particles tighter, and electron transfer between particles easier, thereby reducing the overall resistivity of the material and improving the conductive efficiency. This helps to improve the rate performance and cycling stability of the battery, reduce the internal resistance of the battery, and increase the energy density and power density of the battery. If the oil absorption value of the conductive carbon black is too high, the conductive carbon black is less likely to disperse and thus prone to agglomeration in the electrode plate, deteriorating the conductive network and reducing the rate performance and cycling performance.

When ID/IG of the conductive carbon black is 0.8-1.3, the conductive carbon black has an appropriate quantity of defects and disordered structures. These defects can act as electron trapping and release sites, which facilitates the transport of electrons between carbon black particles, making it easier for electrons to hop in the carbon black network, thereby improving the overall conductive performance of the material and reducing the resistivity. When ID/IG is too small, the conductive carbon black has few surface defects and is prone to agglomeration. When ID/IG is too large, the conductive carbon black has poor conductive performance.

The thermal conductivity of the conductive carbon black being 0.1 W/(m·K)-0.5 W/(m·K) helps to construct a thermal conduction network inside the battery, allowing heat to be evenly distributed and dissipated in a timely manner, and avoiding local overheating that leads to battery performance degradation, capacity decay, and increased side reactions, thereby alleviating battery performance degradation, reducing polarization during charging and discharging, and improving the rate performance.

When the conductive carbon black includes the branched structure formed by stacking the plurality of carbon black units, the branched structure can effectively increase contact points and contact area between the conductive carbon black and surrounding materials. Numerous branches intertwine to construct a denser, more complex, and more efficient conductive network within a matrix material. Electrons can be rapidly transported along these branched structures, significantly improving the conductive performance of the material. In addition, the good bonding between the branched structure and a matrix can form a stronger interface layer within the material. This interface layer can effectively transfer stress, coordinate the deformation between the matrix and the carbon black, and improve the overall mechanical properties of the material. In addition, this interface layer also helps to improve the stability of the material under different environmental conditions, reducing performance degradation caused by problems such as interface debonding.

In some specific embodiments, the conductive carbon black satisfies at least one of the following: (1) the oil absorption value of the conductive carbon black is 350 mL/100 g-400 mL/100 g; (2) ID/IG of the conductive carbon black is 1.0-1.2; or (3) the thermal conductivity of the conductive carbon black is 0.2 W/(m·K)-0.5 W/(m·K).

In the above specific embodiments, the oil absorption value of the conductive carbon black being 350 mL/100 g-400 mL/100 g can ensure good dispersion of carbon black and stability of the conductive network, making the conductive performance of the material more stable under different environmental conditions, avoiding large fluctuations in the conductive performance due to external factors, and improving the reliability and safety of the material.

ID/IG of the conductive carbon black being 1.0-1.2 makes the structure of the conductive carbon black more stable, thereby allowing the resistance performance of the material to be relatively stable, avoiding large fluctuations in the resistance of the material under different environmental conditions and during use, and providing stable conductive performance for electronic devices and the like.

The thermal conductivity of the conductive carbon black being 0.2 W/(m·K)-0.4 W/(m·K) makes the temperature distribution inside the material more uniform, and allows the heat transfer in various parts of the battery to be relatively balanced during charging and discharging, avoiding local overheating, and helping to improve the overall performance and safety of the battery.

According to a second aspect, this application provides a positive electrode plate, where the positive electrode plate includes a binder, a positive electrode active material, and the conductive carbon black according to the first aspect. The positive electrode plate has good electrolyte retention performance and a conductive network, which can further improve the electrochemical performance of an electrochemical apparatus.

In some specific embodiments, the positive electrode plate satisfies at least one of the following: (1) the equivalent diameter of the hole is A (nm), Dᵥ50 of the positive electrode active material is E (μm), and the positive electrode plate satisfies: 0.5≤A/E≤8; (2) the bulk density of the conductive carbon black is F (g/cm³), a tap density of the positive electrode active material is G (g/cm³), a compacted density of the positive electrode plate is H (g/cm³), and the positive electrode plate satisfies: 3.5≤H−F×G≤4.0; or (3) an electrolyte retention rate of the positive electrode plate is 10%-26%.

In the above specific embodiments, the positive electrode plate satisfying 0.5≤A/E≤8 can construct a more efficient electron transport channel. The holes of the conductive carbon black provide a fast transport path for electrons and match with Dᵥ50 of the positive electrode active material, so that a contact effect between the positive electrode active material and the carbon black is improved, making electron transfer between the active material and the conductive carbon black smoother, and reducing charge transfer resistance, thereby improving the charge and discharge efficiency. This further facilitates the diffusion of ions in an electrode material, making an ion transport channel inside an electrode smoother, shortening an ion diffusion path, accelerating an intercalation and deintercalation speed of ions during charging and discharging, and further improving the charge and discharge efficiency of a battery. When A/E is too large, the coating uniformity of an electrolyte around the active material is reduced, affecting the cycling stability and rate performance of the battery. When A/E is too small, the coating continuity of the electrolyte around the active material is poor, thereby affecting the rate performance and cycling stability of the battery. In addition, a decrease in Dᵥ50 of the active material also facilitates improved rate performance, but reduces the cycling stability of the battery at 45° C.

The positive electrode plate satisfying 3.5≤H−F×G≤4.0 can effectively construct a conductive network, ensuring that the active material fully plays its role, thereby increasing the energy density of the battery. In addition, this helps the electrolyte to fully infiltrate the electrode plate, providing more transport channels for lithium ions, shortening diffusion distances of lithium ions inside the active material and between particles, allowing lithium ions to quickly migrate between the electrode and the electrolyte, and improving the rate performance and cycling stability of the battery.

When the electrolyte retention rate of the positive electrode plate is 10%-26%, good infiltration is formed at an interface between the positive electrode plate and the electrolyte, reducing the interface resistance. This helps to improve the kinetic performance of the electrode reaction, making transfer of electrons and ions at the interface easier, reducing the polarization of the battery during charging and discharging, and improving the charge and discharge efficiency and energy output efficiency of the battery.

In some specific embodiments, the positive electrode plate satisfies 1≤A/E≤2, and/or the positive electrode plate satisfies 3.6≤H−F×G≤3.8. When the positive electrode plate satisfies 1≤A/E≤2, and/or the positive electrode plate satisfies 3.6≤H−F×G≤3.8, the charge and discharge efficiency of the battery can be further improved.

According to a third aspect, this application provides an electrochemical apparatus, where the electrochemical apparatus includes the positive electrode plate according to the second aspect, a negative electrode plate, and a separator; and the separator is disposed between the positive electrode plate and the negative electrode plate. The electrochemical apparatus has good low-temperature performance and high-temperature performance.

In some specific embodiments, the separator includes an organic coating, where the organic coating includes hollow microspheres; and the hollow microsphere has a shell layer.

In the above specific embodiments, the hollow microspheres can increase the uniformity of the thickness and porosity of the separator, making the isolation effect of the separator on ions and electrons between positive and negative electrodes better, effectively preventing short circuits between the positive and negative electrodes inside a battery, and improving the safety and stability of the battery. Furthermore, the shell layer of the hollow microsphere can play a certain screening and guiding role in ion transport, allowing beneficial ions such as lithium ions to pass through, while blocking other impurity ions that may cause side reactions, thereby helping to improve the charge and discharge efficiency and cycling performance of the battery.

In some specific embodiments, the electrochemical apparatus satisfies at least one of the following: (1) a thickness of the shell layer is 0.07 μm-0.3 μm; or (2) the separator may further include a base film, a particle size of the hollow microspheres is J (μm), a porosity of the base film is K (%), and the electrochemical apparatus satisfies: 0.01≤J/K≤0.03.

In the above specific embodiments, the thickness of the shell layer being 0.07 μm-0.3 μm helps to adjust the interfacial interaction between the hollow microspheres and surrounding materials (such as an electrolyte and an electrode), making ion exchange and electron transfer at the interface smoother, reducing the interface resistance, and improving the overall performance of the battery.

The electrochemical apparatus satisfying 0.01≤J/K≤0.03 can provide smooth transport channels for lithium ions and the like, improving the ion conduction efficiency, thereby improving the charge and discharge performance and energy density of the battery.

According to a fourth aspect, this application provides an electronic apparatus, where the electronic apparatus includes the electrochemical apparatus according to the third aspect.

### DETAILED DESCRIPTION

To make the objectives, technical solutions, and advantages of some embodiments of this application clearer, the technical solutions in these embodiments of this application will be described clearly and thoroughly below. Apparently, the described embodiments are some but not all of these embodiments of this application. All other embodiments obtained by those of ordinary skill in the art based on these embodiments in this application without creative efforts shall fall within the protection scope of this application.

As used in this application, the terms “include”, “contain”, and “comprise” are used in their open and non-limiting meanings.

Additionally, quantities, ratios, and other numerical values are sometimes presented herein in a range format. It should be understood that such range formats are for convenience and brevity, and should be flexibly interpreted to include not only the numerical values explicitly specified as range limits, but also all individual numerical values or sub-ranges covered within the stated range, as if each numerical value and sub-range are explicitly specified.

In the specific embodiments and claims, a list of items connected by the terms “one or more of”, “one or more pieces of”, “at least one of”, or other similar terms may mean any combination of the listed items. For example, if items A and B are listed, the phrase “at least one of A or B” means A only; B only; or A and B. In another example, if items A, B, and C are listed, the phrase “at least one of A, B, or C” means A only; or B only; C only; A and B (excluding C); A and C (excluding B); B and C (excluding A); or all of A, B, and C. Item A may include a single element or a plurality of elements. Item B may include a single element or a plurality of elements. Item C may include a single element or a plurality of elements.

In the energy sector at present, lithium-ion batteries, with their advantages such as high energy density and long cycle life, are widely used in various fields including mobile electronic devices, electric vehicles, and energy storage systems. With continuous technological advancements and sustained growth in market demand, the requirements for lithium-ion battery performance are becoming increasingly stringent.

In a positive electrode material system of lithium-ion batteries, conductive carbon black occupies an indispensable position and plays an extremely critical role as a commonly used and important conductive additive. Its operating principle is that conductive carbon black can construct an effective conductive network between positive electrode active material particles. During charging and discharging of a battery, electrons can be rapidly and smoothly transported between active material particles through this conductive network, thereby significantly improving the charge and discharge efficiency and overall performance of the battery. However, the existing conductive carbon black currently exhibits obvious shortcomings in electrolyte retention. During use of the battery, the electrolyte is crucial for maintaining ion transport inside the battery, and insufficient electrolyte retention of conductive carbon black means that the electrolyte cannot be effectively adsorbed and retained, leading to uneven electrolyte distribution and electrolyte depletion in some regions. This not only seriously affects the efficiency of ion transport inside the battery but also further limits the exertion of conductivity of the conductive carbon black, ultimately affecting the overall performance of lithium-ion batteries.

Based on the above problems, this application provides a conductive carbon black, a positive electrode plate, an electrochemical apparatus, and an electronic apparatus. The conductive carbon black of this application has good electrolyte retention, thereby increasing an electrolyte retention rate of the positive electrode plate and further improving the performance of the electrochemical apparatus.

Some embodiments of this application are described in detail below.

### Conductive Carbon Black

An embodiment of this application provides a conductive carbon black. The conductive carbon black includes a plurality of carbon black units and pores located between adjacent carbon black units. The carbon black unit includes holes. A bulk density of the conductive carbon black is 0.05 g/cm³-0.1 g/cm³. A pore volume of the hole is 0.05 cm³/g-0.5 cm³/g.

For example, the bulk density of the conductive carbon black may be 0.05 g/cm³, 0.055 g/cm³, 0.06 g/cm³, 0.065 g/cm³, 0.07 g/cm³, 0.075 g/cm³, 0.08 g/cm³, 0.085 g/cm³, 0.09 g/cm³, 0.095 g/cm³, 0.1 g/cm³, or a range defined by any of the above values.

The pore volume of the hole may be 0.05 cm³/g, 0.1 cm³/g, 0.15 cm³/g, 0.2 cm³/g, 0.25 cm³/g, 0.3 cm³/g, 0.35 cm³/g, 0.4 cm³/g, 0.45 cm³/g, 0.5 cm³/g, or a range defined by any of the above values.

Optionally, the bulk density of the conductive carbon black may be 0.055 g/cm³-0.1 g/cm³, 0.06 g/cm³-0.1 g/cm³, 0.06 g/cm³-0.095 g/cm³, 0.06 g/cm³-0.09 g/cm³, 0.06 g/cm³-0.085 g/cm³, or 0.06 g/cm³-0.08 g/cm³.

Optionally, the pore volume of the hole is 0.1 cm³/g-0.5 cm³/g, 0.1 cm³/g-0.45 cm³/g, 0.1 cm³/g-0.4 cm³/g, 0.1 cm³/g-0.35 cm³/g, 0.1 cm³/g-0.3 cm³/g, 0.15 cm³/g-0.5 cm³/g, 0.15 cm³/g-0.45 cm³/g, 0.15 cm³/g-0.4 cm³/g, 0.15 cm³/g-0.35 cm³/g, or 0.15 cm³/g-0.3 cm³/g.

According to this application, the conductive carbon black includes the plurality of carbon black units and the pores located between adjacent carbon black units; and the carbon black unit includes the holes. The bulk density of the conductive carbon black and the pore volume of the hole are adjusted, so that the bulk density of the conductive carbon black is 0.05 g/cm³-0.1 g/cm³, and the pore volume of the hole is 0.05 cm³/g-0.5 cm³/g, allowing the conductive carbon black to form a more efficient conductive network in an electrode of a battery. The bulk density can make carbon black particles be in contact with each other more closely. The pore volume provides more channels for electron transport, facilitating rapid electron migration, reducing the internal resistance of the battery, and improving the charge and discharge efficiency of the battery. The two synergistically accelerate the electron conduction rate of an electrode material, making the performance of the battery more stable during high-current charge and discharge. Furthermore, more storage and transport channels are provided for an electrolyte, allowing the electrolyte to better infiltrate into the electrode material. As an additive of the electrode material, the pores of the conductive carbon black may be in communication with the pores of the electrode, forming a more unobstructed electrolyte transport network, thereby improving the infiltration effect of the electrolyte on the electrode. When the bulk density is too small, a contact area between conductive carbon black particles is too small, which in turn deteriorates the conductive network. When the bulk density is too large, the electrolyte retention of the electrode plate is too high, which leads to a reduction in the electrolyte in electrode plate gaps and an anode electrode, and in turn reduces the cycling performance. When the pore volume is too large, the conductive carbon black easily adsorbs the binder, weakening the dispersion effect of the binder in the system, and the conductive carbon black is prone to agglomeration in the electrode plate, affecting the conductive network, thus reducing the rate performance of the battery. Moreover, an excessively large pore volume causes excessive electrolyte to be stored inside the conductive carbon black, leading to a lack of electrolyte at other positions, thus affecting the cycling performance of the battery.

It should be noted that the bulk density of the conductive carbon black and the pore volume of the hole can be measured using methods and instruments known in the art. For example, a positive electrode plate can be obtained by disassembling an electrochemical apparatus, and then the conductive carbon black can be further obtained by disassembling the positive electrode plate. A mass and volume of the conductive carbon black can be measured respectively according to a method in GB/T 5162-2006 Determination of bulk density of metal powder, and then the bulk density of the conductive carbon black can be calculated according to the formula. A specific surface area and pore size analyzer is used; and based on the Brunauer-Emmett-Teller (BET) theory, a specific surface area of a sample can be calculated by measuring adsorption amounts of gases at different relative pressures and using the BET equation. The principle of pore volume measurement is related to this: when the relative pressure approaches 1, capillary condensation of the gas occurs in mesopores and macropores, and the pore volume can be calculated based on the amount of the condensed gas.

In some embodiments, the equivalent diameter of the hole is 10 nm-45 nm. For example, the equivalent diameter of the hole may be 10 nm, 15 nm, 20 nm, 25 nm, 30 nm, 35 nm, 40 nm, 45 nm, or a range defined by any of the above values.

Optionally, the equivalent diameter of the hole may be 15 nm-45 nm, 15 nm-42 nm, 15 nm-40 nm, 15 nm-38 nm, 15 nm-35 nm, 15 nm-32 nm, or 15 nm-30 nm.

According to the above embodiments, when the equivalent diameter of the hole is 10 nm-45 nm, the electrolyte can enter and exit more easily, increasing an electrolyte retention amount of an electrode plate. In the later stage of cycling, the electrolyte can exude to provide ion pathways, which helps to form a more stable electrode-electrolyte interface on the electrode surface. Furthermore, this allows the electrolyte to be in full contact with the electrode material, forming a uniform interface layer, and reducing stress at the interface and uneven electric field distribution, thereby reducing the interface resistance and improving the cycling stability and service life of the battery.

It should be noted that the equivalent diameter of the hole refers to a diameter of an ideal circular hole that has the same specific properties, such as volume or specific surface area, as the hole. For example, if an irregularly shaped hole has the same volume as an ideal circular hole with a diameter d, d can be considered as an equivalent volume diameter of the irregular hole. The equivalent diameter of the hole can be measured using methods and instruments known in the art. For example, an electrochemical apparatus can be disassembled to obtain a positive electrode plate, and then the positive electrode plate is disassembled to obtain conductive carbon black. Images of the surface of the conductive carbon black can be captured using SEM, TEM, and other microscopes. Professional image processing software, such as ImageJ, can be used to import the captured images into the software, and measurement tools in the software can be used to measure dimensions of the hole in a two-dimensional image, such as area, perimeter, and other parameters; and then the equivalent diameter of the hole can be calculated according to a formula.

In some embodiments, the equivalent diameter of the hole is A (nm), the pore volume of the hole is B (cm³/g), and the conductive carbon black satisfies: 100≤A/B≤300. For example, A/B may be 100, 120, 150, 180, 200, 220, 250, 280, 300, or a range defined by any of the above values.

Optionally, 100≤A/B≤290, 100≤A/B≤280, 100≤A/B≤270, 100≤A/B≤260, 100≤A/B≤250,100≤A/B≤240,100≤A/B≤230,100≤A/B≤220,100≤A/B≤210, or 100≤A/B≤200.

According to the above embodiments, the conductive carbon black satisfying 100≤A/B≤300 allows the equivalent diameter of the hole and the pore volume to cooperate with each other, ensuring that ions have sufficiently large channels to pass through smoothly, and providing the sufficient pore volume to store and buffer ions. In a lithium-ion battery, lithium ions can be rapidly and stably transported between an electrode and an electrolyte during charging and discharging, improving the cycling performance and rate performance of the battery. In addition, optimization of the distribution of reaction sites on the electrode surface is facilitated. A specific surface area of an electrode-electrolyte interface is increased, making the electrode reaction more complete and accelerating the electrode reaction kinetic process, thereby improving the overall performance of the battery and increasing the charging and discharging speed and energy conversion efficiency of the battery.

In some embodiments, the conductive carbon black satisfies at least one of the following: (1) an oil absorption value of the conductive carbon black is 300 mL/100 g-450 mL/100 g; (2) ID/IG of the conductive carbon black is 0.8-1.3; (3) a thermal conductivity of the conductive carbon black is 0.1 W/(m·K)-0.5 W/(m·K); or (4) the conductive carbon black includes a branched structure formed by stacking a plurality of carbon black units.

For example, the oil absorption value of the conductive carbon black may be 300 mL/100 g, 310 mL/100 g, 320 mL/100 g, 330 mL/100 g, 340 mL/100 g, 350 mL/100 g, 360 mL/100 g, 370 mL/100 g, 380 mL/100 g, 390 mL/100 g, 400 mL/100 g, 410 mL/100 g, 420 mL/100 g, 430 mL/100 g, 440 mL/100 g, 450 mL/100 g, or a range defined by any of the above values.

ID/IG of the conductive carbon black may be 0.8, 0.85, 0.9, 0.95, 1, 1.05, 1.1, 1.15, 1.2, 1.25, 1.3, or a range defined by any of the above values.

The thermal conductivity of the conductive carbon black may be 0.1 W/(m·K), 0.15 W/(m·K), 0.2 W/(m·K), 0.25 W/(m·K), 0.3 W/(m·K), 0.35 W/(m·K), 0.4 W/(m K), 0.45 W/(m·K), 0.5 W/(m·K), or a range defined by any of the above values.

Optionally, the oil absorption value of the conductive carbon black may be 310 mL/100 g-450 mL/100 g, 320 mL/100 g-450 mL/100 g, 330 mL/100 g-450 mL/100 g, 340 mL/100 g-450 mL/100 g, 350 mL/100 g-450 mL/100 g, 350 mL/100 g-440 mL/100 g, 350 mL/100 g-430 mL/100 g, 350 mL/100 g-420 mL/100 g, 350 mL/100 g-410 mL/100 g, or 350 mL/100 g-400 mL/100 g.

Optionally, ID/IG of the conductive carbon black may be 0.85-1.3, 0.9-1.3, 0.95-1.3, 1.0-1.3, 1.0-1.25, or 1.0-1.2.

Optionally, the thermal conductivity of the conductive carbon black may be 0.11 W/(m·K)-0.5 W/(m·K), 0.12 W/(m·K)-0.5 W/(m·K), 0.13 W/(m·K)-0.5 W/(m·K), 0.14 W/(m·K)-0.5 W/(m·K), 0.15 W/(m·K)-0.5 W/(m·K), 0.16 W/(m·K)-0.5 W/(m·K), 0.17 W/(m·K)-0.5 W/(m·K), 0.18 W/(m·K)-0.5 W/(m·K), 0.19 W/(m·K)-0.5 W/(m·K), or 0.2 W/(m·K)-0.5 W/(m·K).

According to the above embodiments, when the oil absorption value of the conductive carbon black is 300 mL/100 g-450 mL/100 g, the electrolyte is adsorbed on the surface and in the pores of the conductive carbon black, making the contact between the conductive carbon black particles tighter, and electron transfer between particles easier, thereby reducing the overall resistivity of the material and improving the conductive efficiency. This helps to improve the rate performance and cycling stability of the battery, reduce the internal resistance of the battery, and increase the energy density and power density of the battery. If the oil absorption value of the conductive carbon black is too high, the conductive carbon black is less likely to disperse and thus prone to agglomeration in the electrode plate, deteriorating the conductive network and reducing the rate performance and cycling performance.

When ID/IG of the conductive carbon black is 0.8-1.3, the conductive carbon black has an appropriate quantity of defects and disordered structures. These defects can act as electron trapping and release sites, which facilitates the transport of electrons between carbon black particles, making it easier for electrons to hop in the carbon black network, thereby improving the overall conductive performance of the material and reducing the resistivity. When ID/IG is too small, the conductive carbon black has few surface defects and is prone to agglomeration. When ID/IG is too large, the conductive carbon black has poor conductive performance.

The thermal conductivity of the conductive carbon black being 0.1 W/(m·K)-0.5 W/(m·K) helps to construct a thermal conduction network inside the battery, allowing heat to be evenly distributed and dissipated in a timely manner, and avoiding local overheating that leads to battery performance degradation, capacity decay, and increased side reactions, thereby alleviating battery performance degradation, reducing polarization during charging and discharging, and improving the rate performance.

When the conductive carbon black includes the branched structure formed by stacking the plurality of carbon black units, the branched structure can effectively increase contact points and contact area between the conductive carbon black and surrounding materials. Numerous branches intertwine to construct a denser, more complex, and more efficient conductive network within a matrix material. Electrons can be rapidly transported along these branched structures, significantly improving the conductive performance of the material. In addition, the good bonding between the branched structure and a matrix can form a stronger interface layer within the material. This interface layer can effectively transfer stress, coordinate the deformation between the matrix and the carbon black, and improve the overall mechanical properties of the material. In addition, this interface layer also helps to improve the stability of the material under different environmental conditions, reducing performance degradation caused by problems such as interface debonding.

It should be noted that the oil absorption value, ID/IG, and thermal conductivity of the conductive carbon black as well as the branched structure of the conductive carbon black can all be measured using methods and instruments known in the art. For example, an electrochemical apparatus can be disassembled to obtain a positive electrode plate, and then the positive electrode plate is further disassembled to obtain conductive carbon black. Then, an acid burette can be used to slowly drip DBP purified by vacuum distillation into a carbon black sample, and continuous grinding is performed to make DBP filled in carbon black pores and adsorbed on the surface until a uniform paste without free-flowing liquid and capable of maintaining the shape is formed. The oil absorption value of the conductive carbon black can be calculated based on the consumed DBP volume and the mass of the conductive carbon black using a formula. A Raman spectrometer can be used to measure the Raman spectrum of the conductive carbon black, and software can be used to analyze the Raman spectrum data. A peak fitting function of the software can be used to fit a peak D and a peak G to determine accurate peak positions and peak intensities, and then ID/IG can be further calculated. A heat flow meter method is used; the conductive carbon black is first pressed into a circular sheet or a square sheet with a specific size. Then, a heat flow meter apparatus is checked and calibrated, a sample is then installed, and heating source power is set to create a temperature difference. After the temperature is stabilized, relevant data is recorded to calculate the thermal conductivity of the conductive carbon black. The branched structure of the conductive carbon black can be observed through microscopic images captured by TEM.

### Positive Electrode Plate

An embodiment of this application provides a positive electrode plate, where the positive electrode plate includes a binder, a positive electrode active material, and the aforementioned conductive carbon black. The positive electrode plate has good electrolyte retention performance and a conductive network, which can further improve the electrochemical performance of an electrochemical apparatus.

In some embodiments, the positive electrode plate satisfies at least one of the following: (1) the equivalent diameter of the hole is A (nm), Dᵥ50 of the positive electrode active material is E (μm), and the positive electrode plate satisfies: 0.5≤A/E≤8; (2) the bulk density of the conductive carbon black is F (g/cm³), a tap density of the positive electrode active material is G (g/cm³), a compacted density of the positive electrode plate is H (g/cm³), and the positive electrode plate satisfies: 3.5≤H−F×G≤4.0; or (3) an electrolyte retention rate of the positive electrode plate is 10%-26%.

For example, A/E may be 0.5, 1, 1.5, 2, 2.5, 3, 3.5, 4, 4.5, 5, 5.5, 6, 6.5, 7, 7.5, 8, or a range defined by any of the above values.

H−F×G may be 3.5, 3.55, 3.6, 3.65, 3.7, 3.75, 3.8, 3.85, 3.9, 3.95, 4.0, or a range defined by any of the above values.

The electrolyte retention rate of the positive electrode plate is 10%, 11%, 12%, 13%, 14%, 15%, 16%, 17%, 18%, 19%, 20%, 21%, 22%, 23%, 24%, 25%, 26%, or a range defined by any of the above values.

Optionally, 1≤A/E≤8, 1≤A/E≤7, 1≤A/E≤6, 1≤A/E≤5, 1≤A/E≤4, 1≤A/E≤3, or 1≤A/E≤2.

Optionally, 3.55≤H−F×G≤4.0, 3.6≤H−F×G≤4.0, 3.6≤H−F×G≤3.95, 3.6≤H−F×G≤3.9, 3.6≤H−F×G≤3.85, or 3.6≤H−F×G≤3.8.

According to this embodiment of this application, the positive electrode plate satisfying 0.5≤A/E≤8 can construct a more efficient electron transport channel. The holes of the conductive carbon black provide a fast transport path for electrons and match with Dᵥ50 of the positive electrode active material, so that a contact effect between the positive electrode active material and the carbon black is improved, making electron transfer between the active material and the conductive carbon black smoother, and reducing charge transfer resistance, thereby improving the charge and discharge efficiency. This further facilitates the diffusion of ions in an electrode material, making an ion transport channel inside an electrode smoother, shortening an ion diffusion path, accelerating an intercalation and deintercalation speed of ions during charging and discharging, and further improving the charge and discharge efficiency of a battery. When A/E is too large, the coating uniformity of an electrolyte around the active material is reduced, affecting the cycling stability and rate performance of the battery. When A/E is too small, the coating continuity of the electrolyte around the active material is poor, thereby affecting the rate performance and cycling stability of the battery. In addition, a decrease in Dᵥ50 of the active material also facilitates improved rate performance but reduces the cycling stability of the battery at 45° C.

The positive electrode plate satisfying 3.5≤H−F×G≤4.0 can effectively construct a conductive network, ensuring that the active material fully plays its role, thereby increasing the energy density of the battery. In addition, this helps the electrolyte to fully infiltrate the electrode plate, providing more transport channels for lithium ions, shortening diffusion distances of lithium ions inside the active material and between particles, allowing lithium ions to quickly migrate between the electrode and the electrolyte, and improving the rate performance and cycling stability of the battery.

When the electrolyte retention rate of the positive electrode plate is 10%-26%, good infiltration is formed at an interface between the positive electrode plate and the electrolyte, reducing the interface resistance. This helps to improve the kinetic performance of the electrode reaction, making transfer of electrons and ions at the interface easier, reducing the polarization of the battery during charging and discharging, and improving the charge and discharge efficiency and energy output efficiency of the battery.

It should be noted that A/E, H−F×G, and the electrolyte retention rate of the positive electrode plate can all be measured using methods and instruments known in the art. For example, an electrochemical apparatus is disassembled to obtain a positive electrode plate, and then the positive electrode plate is further disassembled to obtain conductive carbon black and a positive electrode active material. A laser particle size analyzer can be used to measure Dᵥ50 of the positive electrode active material to further obtain A/E. A bulk density of the conductive carbon black, a tap density of the positive electrode active material, and a compacted density of the positive electrode plate can be measured respectively to obtain H−F×G. The dried electrode plate is immersed in a sufficient amount of electrolyte of an appropriate type. After immersion, the electrode plate is taken out and the excess electrolyte is weighed. Then, the surface electrolyte is gently absorbed with quantitative filter paper, and the weight of the electrode plate at this time is recorded. Then, the weight of the electrolyte after immersing the electrode plate is weighed, and then the electrode plate with the surface electrolyte absorbed is dried to obtain a mass of the residual electrolyte of the electrode plate, thereby obtaining the electrolyte retention rate of the positive electrode plate.

### Electrochemical Apparatus

An embodiment of this application provides an electrochemical apparatus, where the electrochemical apparatus includes the positive electrode plate, the negative electrode plate, and the separator as described above; and the separator is disposed between the positive electrode plate and the negative electrode plate. The electrochemical apparatus has good low-temperature performance and high-temperature performance.

In some embodiments, the separator includes an organic coating, where the organic coating includes hollow microspheres; and the hollow microsphere has a shell layer.

In the above embodiments, the hollow microspheres can increase the uniformity of the thickness and porosity of the separator, making the isolation effect of the separator on ions and electrons between positive and negative electrodes better, effectively preventing short circuits between the positive and negative electrodes inside a battery, and improving the safety and stability of the battery. Furthermore, the shell layer of the hollow microsphere can play a certain screening and guiding role in ion transport, allowing beneficial ions such as lithium ions to pass through, while blocking other impurity ions that may cause side reactions, thereby helping to improve the charge and discharge efficiency and cycling performance of the battery.

In some embodiments, the electrochemical apparatus satisfies at least one of the following: (1) a thickness of the shell layer is 0.07 μm-0.3 μm; or (2) the separator may further include a base film, a particle size of the hollow microspheres is J (μm), a porosity of the base film is K (%), and the electrochemical apparatus satisfies: 0.01≤J/K≤0.03.

For example, the thickness of the shell layer may be 0.07 μm, 0.1 μm, 0.12 μm, 0.15 μm, 0.18 μm, 0.2 μm, 0.22 μm, 0.25 μm, 0.28 μm, 0.3 μm, or a range defined by any of the above values.

J/K may be 0.01, 0.011, 0.012, 0.013, 0.014, 0.015, 0.016, 0.017, 0.018, 0.019, 0.02, 0.021, 0.022, 0.023, 0.024, 0.025, 0.026, 0.027, 0.028, 0.029, 0.03, or a range defined by any of the above values.

According to the above embodiments, the thickness of the shell layer being 0.07 μm-0.3 μm helps to adjust the interfacial interaction between the hollow microspheres and surrounding materials (such as an electrolyte and an electrode), making ion exchange and electron transfer at the interface smoother, reducing the interface resistance, and improving the overall performance of the battery.

The electrochemical apparatus satisfying 0.01≤J/K≤0.03 can provide smooth transport channels for lithium ions and the like, improving the ion conduction efficiency, thereby improving the charge and discharge performance and energy density of the battery.

It should be noted that the electrochemical apparatus can be disassembled to obtain the separator, then the separator is further disassembled to obtain the base film and the hollow microspheres. An X-CT method is used to perform multi-angle X-ray scanning of the hollow microspheres, and computer tomography technology is used to reconstruct a three-dimensional structure of a sample. For hollow microspheres, their internal structural information can be intuitively obtained to obtain the thickness of the shell layer and the particle size of the hollow microspheres. A gas adsorption method is used to perform vacuum degassing treatment at a certain temperature to remove impurities and gases adsorbed on the surface. Then, the base film is placed in a sample tube of a gas adsorption instrument, the instrument is cooled to a liquid nitrogen temperature (approximately 77K), a nitrogen gas is introduced at different pressures, and an adsorption amount of the nitrogen gas is measured. By analyzing the adsorption isotherm, methods such as the BET equation are used to calculate a specific surface area of the sample, and then the porosity is calculated using relevant models.

In some embodiments, the electrochemical apparatus further includes a positive electrode plate, a negative electrode plate, and a separator, where the positive electrode plate and the negative electrode plate are separated by the separator disposed therebetween. In some embodiments, the positive electrode plate includes a positive electrode current collector and a positive electrode active material layer disposed on the positive electrode current collector, where the positive electrode active material layer may include a positive electrode active material. The negative electrode plate includes a negative electrode current collector and a negative electrode active material layer disposed on the negative electrode current collector, where the negative electrode active material layer may include a negative electrode active material.

In some embodiments, the negative electrode plate may include a negative electrode current collector and a negative electrode active material layer disposed on the negative electrode current collector. The negative electrode active material layer may be disposed on one or both sides of the negative electrode current collector. In some embodiments, the negative electrode current collector may be at least one of a copper foil, a nickel foil, or a carbon-based current collector. In some embodiments, a thickness of the negative electrode current collector may be 1 μm-200 μm. In some embodiments, the negative electrode active material layer may be applied only on a partial region of the negative electrode current collector. In some embodiments, a thickness of the negative electrode active material layer may be 10 μm-500 μm. It should be understood that these are merely exemplary, and other suitable thicknesses may be used.

In some embodiments, as described above, the negative electrode active material layer includes a negative electrode active material. In some embodiments, the negative electrode active material includes at least one of natural graphite, artificial graphite, or a silicon-based material. In some embodiments, the silicon-based material includes at least one of silicon, a silicon-oxygen compound, a silicon-carbon compound, or a silicon alloy.

In some embodiments, the negative electrode active material layer may further include a negative electrode conductive agent and/or a negative electrode binder. The negative electrode conductive agent may include at least one of carbon black, acetylene black, Ketjen black, graphene, carbon nanotubes, or carbon fiber. In some embodiments, the negative electrode binder may include at least one of carboxymethyl cellulose (CMC), polyacrylic acid, polyacrylate salt, polyacrylate ester, polyvinylpyrrolidone, polyimide, polysiloxane, or styrene-butadiene rubber. It should be understood that the materials disclosed above are merely exemplary, and the negative electrode active material layer may use any other suitable material. In some embodiments, a mass ratio of the negative electrode active material, negative electrode conductive agent, and negative electrode binder in the negative electrode active material layer may be (80-99):(0.5-10):(0.5-10). It should be understood that this is merely exemplary and is not intended to limit this application.

In some embodiments, the positive electrode plate includes a positive electrode current collector and a positive electrode active material layer disposed on the positive electrode current collector. The positive electrode active material layer may be located on one or both sides of the positive electrode current collector. In some embodiments, the positive electrode current collector may be an aluminum foil, but other positive electrode current collectors commonly used in the art can also be used. In some embodiments, a thickness of the positive electrode current collector may be 1 μm-200 μm. In some embodiments, the positive electrode active material layer may be applied only on a partial region of the positive electrode current collector. In some embodiments, a thickness of the positive electrode active material layer may be 10 μm-500 μm. It should be understood that these are merely exemplary, and other suitable thicknesses may be used.

In some embodiments, as described above, the positive electrode active material layer includes a positive electrode active material. In some embodiments, the positive electrode active material may include at least one of lithium cobalt oxide, lithium manganese oxide, lithium iron phosphate, lithium manganese iron phosphate, lithium nickel cobalt manganese oxide, lithium nickel cobalt aluminum oxide, or lithium nickel manganese oxide. The above positive electrode active materials may be doped and/or coated.

In some embodiments, a surface of the positive electrode material includes lithium phosphate and/or lithium niobate, where a mass ratio of the two is 1:5-1:1, and a thickness of a covering layer is 1 μm-2 μm.

In some embodiments, the positive electrode active material layer further includes a positive electrode binder and a positive electrode conductive agent. In some embodiments, the positive electrode binder may include at least one of polyvinylidene fluoride, vinylidene fluoride-hexafluoropropylene copolymer, styrene-acrylate copolymer, styrene-butadiene copolymer, polyamide, polyacrylonitrile, polyacrylate ester, polyacrylic acid, polyacrylate salt, sodium carboxymethyl cellulose, polyvinyl acetate, polyvinylpyrrolidone, polyvinyl ether, polytetrafluoroethylene, or polyhexafluoropropylene. In some embodiments, the positive electrode conductive agent may include at least one of conductive carbon black, acetylene black, Ketjen black, graphene, carbon nanotubes, or carbon fiber.

In this application, the electrochemical apparatus includes an electrolyte, where the electrolyte includes a lithium salt and a non-aqueous solvent. This application does not particularly limit the lithium salt, provided the objectives of this application can be achieved. For example, the lithium salt may include but is not limited to at least one of LiPF₆, LiBF₄, LiClO₄, LiB(C₆H₅)₄, LiCH₃SO₃, LiCF₃SO₃, LiN(SO₂CF₃)₂, LiC(SO₂CF₃)₃, Li₂SiF₆, lithium bis(oxalate) borate (LiBOB), or lithium difluoroborate. This application does not particularly limit a percentage of the lithium salt in the electrolyte, provided that the objectives of this application can be achieved. For example, based on a mass of the electrolyte, a mass percentage of the lithium salt is 5% to 23%. For example, a concentration of the lithium salt in the electrolyte may be 5%, 8%, 12%, 16%, 20%, 23%, or a range defined by any two of the above values. This application does not particularly limit the non-aqueous solvent, provided that the objectives of this application can be achieved. For example, the non-aqueous solvent may include but is not limited to at least one of a carbonate compound, a carboxylate compound, an ether compound, or another organic solvent. The above carbonate compound may include but is not limited to at least one of a linear carbonate compound, a cyclic carbonate compound, or a fluorinated carbonate compound. The above linear carbonate compound may include but is not limited to at least one of dimethyl carbonate (DMC), diethyl carbonate (DEC), dipropyl carbonate (DPC), methyl propyl carbonate (MPC), ethyl propyl carbonate (EPC), or methyl ethyl carbonate (MEC). The above cyclic carbonate may include but is not limited to at least one of ethylene carbonate (EC), propylene carbonate (PC), butylene carbonate (BC), or vinylene ethylene carbonate (VEC). The fluorinated carbonate compound may include but is not limited to at least one of 1,2-difluoroethylene carbonate, 1,1-difluoroethylene carbonate, 1,1,2-trifluoroethylene carbonate, 1,1,2,2-tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, or trifluoromethylethylene carbonate. The above carboxylate compound may include but is not limited to at least one of methyl formate, methyl acetate, ethyl acetate, n-propyl acetate, tert-butyl acetate, methyl propionate, ethyl propionate, propyl propionate, γ-butyrolactone, decalactone, valerolactone, or caprolactone. The above ether compound may include but is not limited to at least one of dibutyl ether, tetraglyme, diglyme, 1,2-dimethoxyethane, 1,2-diethoxyethane, 1-ethoxy-1-methoxyethane, 2-methyltetrahydrofuran, or tetrahydrofuran. The above another organic solvent may include but is not limited to at least one of dimethyl sulfoxide, 1,2-dioxolane, sulfolane, methyl sulfolane, 1,3-dimethyl-2-imidazolidinone, N-methyl-2-pyrrolidone, dimethylformamide, acetonitrile, trimethyl phosphate, triethyl phosphate, or trioctyl phosphate. This application does not particularly limit the content of the non-aqueous solvent in the electrolyte, provided that the objectives of this application can be achieved.

In some embodiments, the separator includes at least one of polyethylene, polypropylene, polyvinylidene fluoride, polyethylene terephthalate, polyimide, or aramid. For example, polyethylene includes at least one selected from high-density polyethylene, low-density polyethylene, or ultra-high molecular weight polyethylene. Especially polyethylene and polypropylene, they have good effects in preventing short circuits and can improve the safety of the battery through the shutdown effect. In some embodiments, a thickness of the separator is in a range of about 3 μm-480 μm.

In some embodiments, the separator has a porous layer. A binder of the porous layer is selected from at least one of polyvinylidene fluoride, vinylidene fluoride-hexafluoropropylene copolymer, polyamide, polyacrylonitrile, polyacrylate ester, polyacrylic acid, polyacrylate salt, sodium carboxymethyl cellulose, polyvinylpyrrolidone, polyvinyl ether, polytetrafluoroethylene, or polyhexafluoropropylene. The porous layer on the surface of the separator can improve the heat resistance, oxidation resistance, and electrolyte infiltration performance of the separator, and enhance the adhesion between the separator and the electrode plate. The separator may further include one of a high-melting-point crystalline polymer or a high-temperature-resistant amorphous polymer. The high-temperature-resistant resin includes at least one of polypropylene, poly-4-methylpentene, polytetrafluoroethylene, polyvinylidene fluoride, and cyclic olefin copolymer. The high-melting-point crystalline polymer includes at least one of polypropylene, poly-4-methylpentene, polytetrafluoroethylene, or polyvinylidene fluoride. The high-temperature-resistant amorphous polymer includes cyclic olefin copolymer. Based on a mass of a polyolefin porous substrate, a mass percentage Z of the high-temperature-resistant resin is 2%-10%. For example, the mass percentage Z of the high-temperature-resistant resin is 2%, 3%, 5%, 7%, 8%, 10%, or a range defined by any two of these values. Adding the above types of high-temperature-resistant resins to the polyolefin porous substrate and controlling the mass percentage of the high-temperature-resistant resin within the above range help to increase a melt-rupture temperature of the separator, improving the strength and the high-temperature performance of the electrochemical apparatus.

In some embodiments, the electrochemical apparatus is a lithium-ion battery, but this application is not limited thereto.

In some embodiments of this application, taking a lithium-ion battery as an example, the positive electrode plate, the separator, and the negative electrode plate are wound or stacked in order to form an electrode assembly. The electrode assembly is then packaged in a casing such as an aluminum-plastic film, followed by electrolyte injection, formation, and sealing, to obtain the lithium-ion battery.

### Preparation Method of Conductive Carbon Black

A raw material is placed in a reaction furnace and subjected to a pyrolysis reaction at a high temperature of 1000° C. to 1500° C. to produce carbon black particles. The carbon black particles are then blown out of a furnace tube, cooled, and collected. This application does not particularly limit the type of the raw material, provided that the objectives of this application can be achieved. For example, the raw material may include but is not limited to acetylene or tar.

### Electronic Apparatus

An embodiment of this application further provides an electronic apparatus including the electrochemical apparatus described above. The electronic apparatus of this embodiment of this application is not particularly limited, and it may be any electronic apparatus known in the prior art. In some embodiments, the electronic apparatus may include but is not limited to a laptop computer, a pen-input computer, a mobile computer, an e-book player, a portable telephone, a portable fax machine, a portable copier, a portable printer, a head-mounted stereo headphone, a video recorder, a liquid crystal television, a portable cleaner, a portable CD player, a mini disc, a transceiver, an electronic notebook, a calculator, a memory card, a portable recorder, a radio, a backup power source, a motor, an automobile, a motorcycle, an electric bicycle, a bicycle, a lighting fixture, a toy, a game console, a clock, a power tool, a flashlight, a camera, a large household battery, and a lithium-ion capacitor.

### Test Section

A test method was as follows:

### 1. Electrolyte Retention Rate of Positive Electrode Plate:

a. A battery cell was fully discharged to 3.0 V and then disassembled to obtain a positive electrode plate. The positive electrode plate was immersed in DMC at (25±3° C.) for 30 min, then taken out, and air-dried for 3 h.
b. Parts of the positive electrode plate from step a with surfaces A and B coated with films were taken and weighed, with the weight recorded as M1. The electrode plate was fully immersed in an electrolyte at (85±3° C.) for 2 h. Then, the electrode plate was taken, air-dried at (25±3° C.) with a humidity of 1%-10% for 10 min, and then weighed, with the weight recorded as M2. An electrolyte retention rate of the positive electrode plate was calculated as (M2-M1)/M1.

### 2. Cycling Capacity Retention Rate:

A lithium-ion battery from an example or a comparative example was taken and subjected to the following tests at −10±2° C., 45±2° C., or 60±2° C.:
(1) The lithium-ion battery was left standing for 2 h, discharged at a constant current of 0.5C to 3.0 V, and then left standing for 5 min.
(2) The lithium-ion battery was charged at a constant current of 1.0C to 4.5 V and then charged at a constant voltage of 4.5 V until the current was less than or equal to 0.05C. Then, the lithium-ion battery was left standing for 5 min and then discharged at a constant current of 0.5C to 3.0 V. A discharge capacity at this point was recorded as C1. Then, the lithium-ion battery was left standing for 5 min. 49 cycles were performed according to the above steps. Then, the 50th cycle was performed. The 50th cycle was performed as follows: the lithium-ion battery was charged at a constant current of 1.0C to 4.5 V, charged at a constant voltage of 4.5 V until the current was less than or equal to 0.05C, left standing for 5 min, and then discharged at a constant current of 0.2C to 3.0 V.
(3) Then, after step (2) was repeated for 10 times, the lithium-ion battery was charged at a constant current of 1.0C to 4.5 V, then charged at a constant voltage of 4.5 V until the current was less than or equal to 0.05C, left standing for 5 min, and then discharged at a constant current of 0.5C to 3.0 V. A capacity of the lithium-ion battery at the 501st cycle was recorded as C501. A capacity retention rate of the lithium-ion battery after 500 cycles at 45° C. was calculated as C501/C1.

### 3. Discharge Rate:

A lithium-ion battery from an example or a comparative example was taken and subjected to the following tests at 25±2° C.:

(1) The lithium-ion battery was left standing for 2 h, discharged at a constant current of 0.5C to 3.0 V, and then left standing for 5 min.

(2) The lithium-ion battery was charged at a constant current of 1.0C to 4.5 V and then charged at a constant voltage of 4.5 V until the current was less than or equal to 0.05C. Then, the lithium-ion battery was left standing for 5 min and then discharged at a constant current of 0.2C to 3.0 V. A discharge capacity at this point was recorded as C₀. Then, the lithium-ion battery was left standing for 5 min, charged at a constant current of 1.0C to 4.5 V, charged at a constant voltage of 4.5 V until the current was less than or equal to 0.05C, left standing for 5 min, and then discharged at a constant current of 2C to 3.0 V. A discharge capacity at this point was recorded as C₁. A discharge rate at 2C was calculated as C₁/C₀. Test methods of a discharge rate at 3C and a discharge rate at 4C were similar to the above method.

### 4. Bulk Density of Conductive Carbon Black:

a. 5 g to 7 g of conductive carbon material was taken, dried in an oven at 105±2° C. for 1 hour, and cooled in a desiccator to (25±3° C.)
b. The dried carbon powder from step a was put into a tap density tester. The model of the tap density tester might be VTD-100. The weight of the carbon powder was recorded as M (g). The vibration frequency of a vibrator was set to 250 times per min. After vibration was performed three times, a volume of the carbon powder was recorded as V (cm³). A bulk density (g/cm³) of a first carbon material was calculated as M/V.

### 5. Pore Volume & Equivalent Diameter of Conductive Carbon Black:

a. 0.2 g of conductive carbon black was weighed, and a mass (m) was recorded.
b. The sample was placed in a sample container and dried in an oven at 105±2° C. for 2 hours to remove moisture and adsorbed gases on the surface. After the sample was dried, the sample was cooled to room temperature.
c. The dried sample was transferred to a sample tube of a specific surface area and porosity analyzer (model ASAP 2460 Version 3.01), and uniform distribution of the sample was ensured. The sample tube was sealed and connected to a test system of the analyzer.
d. The sample tube was vacuumized and typically degassed at about 100° C. for 1-2 hours, to further remove adsorbed gases and moisture on the surface of the sample.
e. The sample tube was cooled to a liquid nitrogen temperature (approximately −196° C.). A nitrogen gas at a certain pressure was filled into the sample tube. Adsorption amounts of the nitrogen gas at different pressures were measured.
f. Multi-point measurements were typically performed at different relative pressures (p/p₀), where (p) was the pressure of the nitrogen gas, and (p₀) is a saturated vapor pressure of the nitrogen gas. A p/p₀ selection range was 0.05-0.30. For example, 0.05, 0.10, 0.20, and 0.30 were selected for measurement.
g. After measurement, in the report output by the instrument, the pore volume & equivalent diameter of the conductive carbon black under the BJH algorithm (Barrett, Joyner, and Halenda Algorithm) was selected.
   6. Oil Absorption Value of Conductive Carbon Black: a Paraffin Oil and a Torque Method were Used for Test.

A DABS-H model oil absorption meter was selected. Carbon powder was added to a mixing tank of the oil absorption meter, and paraffin oil was added to a sample at a constant dripping speed of 4 ml/min using a constant-rate dropper. As an oil absorption value of the sample increased, a mixture changed from a free-flowing state to a semi-plastic agglomerate, and the viscosity of the mixture continuously increased. This viscosity was transmitted to a torque sensing system of the oil absorption meter. When the viscosity of the mixture reached a predetermined torque value, the oil absorption meter and the dropper were automatically shut off simultaneously. The volume of oil added was read directly from a reading burette, and a volume of oil absorbed per unit mass of the sample at 70% of the predetermined torque was selected as an oil absorption value of the sample.

### 7. ID/IG of Conductive Carbon Black:

A laser confocal Raman spectrometer (model HR Evolution, HORIBA Scientific Instruments Division) was used to test the Raman spectrum of carbon black particles. For the carbon black particles, a peak intensity at 1350 cm⁻¹ was ID1, and a peak intensity at 1580 cm⁻¹ was IG1. A ID1/IG1 value of the carbon black particles was obtained by the following method: the carbon black particles were placed on a Raman test sample stage, and the Raman spectrum of the carbon black particles was tested to obtain the ID1/IG1 value. Test was performed 12 times, and an average was taken as the ID/IG value of the carbon black particles.

### 8. Thermal Conductivity of Conductive Carbon Black: a Hot Disk TPS 2500 S Tester was Used, and a Heat Flow Method was Used for Test.

a. A sample was placed between a hot disk (a heat source) and a temperature sensor. A flat surface and uniform thickness of the sample were ensured. The conductive carbon black might be powder compacted into blocks.
b. Test parameters: Test time was 20 s, heating power was 3 W, a sample thickness was (2±0.5) mm, and a temperature range was (25±3° C.)
c. After the test, a thermal conductivity of the conductive carbon black was read directly from the instrument. Measurement was performed three times, and an average was taken as the final result.

### EXAMPLES

The following examples describe the content disclosed in this application more specifically. These examples are for illustrative purposes only, as various modifications and changes made within the scope of the content disclosed in this application are apparent to those skilled in the art. Unless otherwise stated, all parts, percentages, and ratios reported in the following examples are measured based on weight, and all reagents used in the examples are commercially available or synthesized by conventional methods and can be used directly without further processing, and the instruments used in the examples are commercially available.

Some specific examples and comparative examples are listed below to better illustrate this application, where lithium-ion batteries are used as examples.

### Example 1-1

Natural gas was filled in a reaction furnace and undergone a pyrolysis reaction at a high temperature of 1000° C. to 1500° C. to generate carbon black particles. The carbon black particles were blown out of a furnace tube, cold-pressed for 5 minutes, cooled to 20° C., and collected, with the parameters of the conductive carbon black shown in Table 1.

Positive electrode: Lithium cobalt oxide, conductive graphite, and polyvinylidene fluoride were mixed at a weight ratio of 88:6:6, added to N-methylpyrrolidone, and stirred into a uniform slurry. The slurry was then stirred, applied, dried, rolled, and spot-welded with tabs to obtain a battery positive electrode.

Electrolyte: In an argon-filled glove box, ethylene carbonate, dimethyl carbonate, and methyl ethyl carbonate were mixed at a mass ratio of 3:4:3. Propyl propionate, accounting for 20% of a total mass of the electrolyte, was added. A certain amount of lithium hexafluorophosphate was added, so that based on the total mass of the electrolyte, a mass percentage of lithium hexafluorophosphate was 8.5%. A certain amount of fluoroethylene carbonate was added, so that based on the total mass of the electrolyte, a mass percentage of fluoroethylene carbonate was 2.5%.

Separator: First filler particles, second microsphere filler particles, and a polyacrylic acid binder were fully dispersed uniformly in deionized water according to a solid content mass ratio of 91:5:4 to obtain a porous coating slurry. The porous coating slurry was uniformly applied on both surfaces of a 5 μm thick polyethylene porous substrate, and then dried in an oven to obtain a separator. A thickness of the porous coating was 2 μm, and a thickness of the separator was 9 μm. The first filler particles were boehmite with an average particle size of 1 μm. The second microsphere filler particle included a cavity and a shell encapsulating the cavity. The shell included a plurality of pore structures. The shell included a first shell layer and a second shell layer, where the second shell layer was located between the first shell layer and the cavity of the second microsphere filler particle, the first shell layer was polystyrene, and the second shell layer was a copolymer of n-butyl acrylate-methyl acrylate-ethylene glycol dimethacrylate. A mass ratio of n-butyl acrylate, methyl acrylate, and ethylene glycol dimethacrylate was 40:60:0.5. The first shell layer and the second shell layer were connected by C—C covalent bonds. A diameter of the cavity was 0.6 μm. An average thickness of the shell was 0.1 μm. An average particle size of the second microsphere filler particles was 0.8 μm. A ratio of the diameter of the cavity of the second microsphere filler particle to the average particle size of the second microsphere filler particles was 0.75:1.

Negative electrode: Artificial graphite as a negative electrode active material, conductive carbon black as a conductive agent, styrene-butadiene rubber (SBR) as a binder, and sodium carboxymethyl cellulose (CMC) as a thickener were mixed at a weight ratio of 97:1:1:1, and deionized water was added. The mixture was stirred well under vacuum to obtain a negative electrode slurry, where a solid content of the negative electrode slurry was 80 wt %. The negative electrode slurry was uniformly applied on one side surface of a copper foil as a negative electrode current collector, and dried at 110° C. to obtain a negative electrode plate with one surface coated with a negative electrode active material layer having a thickness of 90 μm. The above steps were repeated on the other side surface of the copper foil as the negative electrode current collector to obtain a negative electrode plate with double surfaces coated with negative electrode active material layers. After cold pressing, slitting, and cutting were performed, a negative electrode plate with a specification of 476 mm×93.5 mm was obtained. Sheet resistance tested of the negative electrode plate was 0.002 mΩ/cm².

Preparation of lithium-ion battery: A lithium iron phosphate positive electrode plate, a separator, and a silicon-carbon negative electrode as a negative electrode plate were stacked in sequence, so that the separator was located between the positive electrode plate and the negative electrode plate for isolation. The resulting stack was wound to form an electrode assembly. After tab welding was performed, the electrode assembly was placed in an aluminum-plastic film as an outer package. After dehydration was performed at 80° C., the aforementioned electrolyte was injected. After processes such as vacuum packaging, standing, formation, shaping, and capacity testing were performed, a lithium-ion battery was obtained.

### Examples 1-2 to 1-20 and Comparative Examples 1-1 to 1-6

The preparation of the lithium-ion batteries in these examples was substantially the same as that in Example 1-1, with only differences in the bulk density of the conductive carbon black, the pore volume of the hole, the equivalent diameter of the hole, A/B, and the oil absorption value of the conductive carbon black, with the specific parameters shown in Table 1.

The electrolyte retention rate of the positive electrode plate was tested, and the cycling capacity retention rate at 45° C. and discharge rate at 2C of the lithium-ion battery were tested, with the results shown in Table 1.

TABLE 1

| | | Pore | | | | | | |
|---|---|---|---|---|---|---|---|---|
| | | volume | Equivalent | | Oil | Electrolyte | Cycling capacity | |
| | Bulk | B of | diameter A | | absorption | retention rate of | retention rate | Discharge |
| | density | hole | of hole | | value | positive electrode | after 500 cycles | rate at 2 C |
| | (g/cm³) | (cm³/g) | (nm) | A/B | (mL/100 g) | plate (%) | at 45° C. (%) | (%) |
| Example 1-1 | 0.05 | 0.15 | 20 | 133 | 450 | 26 | 75 | 91 |
| Example 1-2 | 0.055 | 0.15 | 20 | 133 | 420 | 23 | 76 | 93 |
| Example 1-3 | 0.06 | 0.15 | 20 | 133 | 400 | 21 | 79 | 95 |
| Example 1-4 | 0.07 | 0.15 | 20 | 133 | 380 | 18 | 81 | 98 |
| Example 1-5 | 0.08 | 0.15 | 20 | 133 | 350 | 16 | 78 | 94 |
| Example 1-6 | 0.09 | 0.15 | 20 | 133 | 330 | 13 | 76 | 92 |
| Example 1-7 | 0.1 | 0.15 | 20 | 133 | 300 | 10 | 74 | 91 |
| Example 1-8 | 0.05 | 0.05 | 20 | 400 | 380 | 26 | 71 | 90 |
| Example 1-9 | 0.05 | 0.1 | 20 | 200 | 380 | 21 | 72 | 91 |
| Example 1-10 | 0.05 | 0.2 | 20 | 100 | 380 | 17 | 79 | 94 |
| Example 1-11 | 0.05 | 0.3 | 20 | 67 | 380 | 16 | 77 | 93 |
| Example 1-12 | 0.05 | 0.4 | 20 | 50 | 380 | 14 | 70 | 90 |
| Example 1-13 | 0.05 | 0.5 | 20 | 40 | 380 | 13 | 70 | 89 |
| Example 1-14 | 0.07 | 0.15 | 5 | 33 | 380 | 18 | 72 | 96 |
| Example 1-15 | 0.07 | 0.15 | 10 | 67 | 380 | 18 | 76 | 96 |
| Example 1-16 | 0.07 | 0.15 | 15 | 100 | 380 | 18 | 79 | 95 |
| Example 1-17 | 0.07 | 0.15 | 30 | 200 | 380 | 18 | 79 | 95 |
| Example 1-18 | 0.07 | 0.15 | 40 | 267 | 380 | 18 | 77 | 93 |
| Example 1-19 | 0.07 | 0.15 | 45 | 300 | 380 | 18 | 76 | 92 |
| Example 1-20 | 0.07 | 0.15 | 50 | 333 | 380 | 18 | 73 | 89 |
| Comparative | 0.04 | 0.04 | 20 | 500 | 380 | 28 | 67 | 85 |
| Example 1-1 | | | | | | | | |
| Comparative | 0.095 | 0.55 | 20 | 36 | 380 | 11 | 70 | 86 |
| Example 1-2 | | | | | | | | |
| Comparative | 0.03 | 0.15 | 20 | 133 | 380 | 28 | 65 | 84 |
| Example 1-3 | | | | | | | | |
| Comparative | 0.15 | 0.15 | 20 | 133 | 380 | 8 | 63 | 83 |
| Example 1-4 | | | | | | | | |
| Comparative | 0.03 | 0.10 | 20 | 200 | 380 | 6 | 59 | 78 |
| Example 1-5 | | | | | | | | |
| Comparative | 0.15 | 0.60 | 20 | 33 | 380 | 4 | 60 | 76 |
| Example 1-6 | | | | | | | | |

According to Table 1, compared to the comparative examples, the electrolyte retention rate of the positive electrode plate in each of the examples is controlled within the range of this application, and the cycling capacity retention rate at 45° C. and discharge rate at 2C of the lithium-ion battery are significantly improved. When the conductive carbon black of this application is used, and the bulk density of the conductive carbon black and the pore volume of the hole both satisfy the ranges of this application, the two synergistically allow the lithium-ion battery to have good cycling performance and charge and discharge performance.

According to Examples 1-1 to 1-13 and Comparative Examples 1-1 to 1-6, it can be seen that when the bulk density of the conductive carbon black is 0.05 g/cm³-0.1 g/cm³ and the pore volume of the hole is 0.05 cm³/g-0.5 cm³/g, the lithium-ion battery has better cycling performance and charge and discharge performance.

On this basis, according to Examples 1-3 to 1-6 and Examples 1-9 to 1-11, it can be seen that when the bulk density of the conductive carbon black is 0.06 g/cm³-0.08 g/cm³, and/or the pore volume of the hole is 0.15 cm³/g-0.3 cm³/g, the lithium-ion battery has better cycling performance and charge and discharge performance.

According to Examples 1-1 to 1-7, it can be seen that when the oil absorption value of the conductive carbon black is 300 mL/100 g-450 mL/100 g, the lithium-ion battery has relatively good cycling performance and charge and discharge performance.

On this basis, according to Examples 1-3 to 1-5, it can be seen that when the oil absorption value of the conductive carbon black is 350 mL/100 g-400 mL/100 g, the lithium-ion battery has better cycling performance and charge and discharge performance.

According to Examples 1-14 to 1-20, it can be seen that when the equivalent diameter of the hole is 10 nm-45 nm or 100≤A/B≤300, the lithium-ion battery has relatively good cycling performance and charge and discharge performance.

On this basis, according to Examples 1-16 and 1-17, it can be seen that when the equivalent diameter of the holes is 15 nm-30 nm or 100≤A/B≤200, the lithium-ion battery has better cycling performance and charge and discharge performance.

### Examples 2-1 to 2-12

The preparation of the lithium-ion batteries in these examples was substantially the same as that in Example 1-1, with only differences in ID/IG and thermal conductivity of the conductive carbon black, with the specific parameters shown in Table 2.

The cycling capacity retention rate at 60° C. and discharge rate at 3C of the lithium-ion battery were tested, with the results shown in Table 2.

TABLE 2

| | | Thermal | Capacity retention | Discharge |
|---|---|---|---|---|
| | ID/ | conductivity | rate after 500 cycles | rate at |
| | IG | (W/(m · K)) | at 60° C. (%) | 3 C (%) |
| Example 1-4 | 1.1 | 0.3 | 80 | 96 |
| Example 2-1 | 0.8 | 0.3 | 78 | 93 |
| Example 2-2 | 0.9 | 0.3 | 79 | 94 |
| Example 2-3 | 1.0 | 0.3 | 81 | 95 |
| Example 2-4 | 1.2 | 0.3 | 79 | 97 |
| Example 2-5 | 1.3 | 0.3 | 77 | 97.5 |
| Example 2-6 | 1.1 | 0.1 | 78 | 94 |
| Example 2-7 | 1.1 | 0.2 | 79 | 95 |
| Example 2-8 | 1.1 | 0.4 | 81 | 97 |
| Example 2-9 | 1.1 | 0.5 | 82 | 98 |
| Example 2-10 | 0.7 | 0.3 | 75 | 91 |
| Example 2-11 | 1.4 | 0.3 | 74 | 98 |
| Example 2-12 | 1.1 | 0.05 | 75 | 91 |

According to Table 2, when ID/IG and the thermal conductivity of the conductive carbon black are controlled within the ranges of this application, the lithium-ion battery has good high-temperature cycling performance and charge and discharge performance.

According to Example 1-4, Examples 2-1 to 2-5, and Examples 2-10 and 2-11, it can be seen that when ID/IG of the conductive carbon black is 0.8-1.3, the lithium-ion battery has relatively good high-temperature cycling performance and charge and discharge performance.

On this basis, according to Example 1-4 and Examples 2-3 and 2-4, it can be seen that when ID/IG of the conductive carbon black is 1.0-1.2, the lithium-ion battery has relatively good high-temperature cycling performance and charge and discharge performance.

According to Example 1-4, Examples 2-6 to 2-9, and Example 2-12, it can be seen that when the thermal conductivity of the conductive carbon black is 0.1 W/(m·K)-0.5 W/(m·K), the lithium-ion battery has relatively good high-temperature cycling performance and charge and discharge performance.

### Examples 3-1 to 3-26

The preparation of the lithium-ion batteries in these examples was substantially the same as that in Example 1-4, with only differences in the equivalent diameter of the hole, Dᵥ50 of the positive electrode active material, A/E, H−F×G, the thickness of the shell layer, the porosity of the base film, and J/K. The difference between Example 3-27 and Example 1-1 was that the separator coating in Example 3-27 included no microsphere structure, with the specific parameters shown in Table 3.

The cycling capacity retention rate at −10° C. and discharge rate at 4C of the lithium-ion battery were tested, with the results shown in Table 3.

TABLE 3

| | | Bulk | | | | Tap | | | | | | Capacity | |
|---|---|---|---|---|---|---|---|---|---|---|---|---|---|
| | | density | Dᵥ50 | | Compacted | density | | | Particle | | | retention | |
| | | F of | E of | | density | G of | | | size | | | rate | |
| | Equivalent | conduc- | positive | | H of | positive | | Thick- | J of | Porosity | | after | Dis- |
| | diameter | tive | electrode | | positive | electrode | | ness of | hollow | K of | | 500 | charge |
| | A of | carbon | active | | electrode | active | H − | shell | micro- | base | | cycles | rate at |
| | hole | black | material | | plate | material | F × | layer | spheres | film | | at −10° C. | 4 C |
| | (nm) | (cm³/g) | (μm) | A/E | (g/cm³) | (g/cm³) | G | (μm) | (μm) | (%) | J/K | (%) | (%) |
| Example 1-4 | 20 | 0.07 | 15 | 1.3 | 4.0 | 1.8 | 3.9 | 0.1 | 0.6 | 45 | 0.0133 | 80 | 93 |
| Example 3-1 | 20 | 0.07 | 5 | 4.0 | 4.0 | 1.8 | 3.9 | 0.1 | 0.6 | 45 | 0.0133 | 74 | 98 |
| Example 3-2 | 20 | 0.07 | 8 | 2.5 | 4.0 | 1.8 | 3.9 | 0.1 | 0.6 | 45 | 0.0133 | 76 | 97 |
| Example 3-3 | 20 | 0.07 | 10 | 2.0 | 4.0 | 1.8 | 3.9 | 0.1 | 0.6 | 45 | 0.0133 | 79 | 97 |
| Example 3-4 | 20 | 0.07 | 20 | 1.0 | 4.0 | 1.8 | 3.9 | 0.1 | 0.6 | 45 | 0.0133 | 79 | 94 |
| Example 3-5 | 20 | 0.07 | 22 | 0.9 | 4.0 | 1.8 | 3.9 | 0.1 | 0.6 | 45 | 0.0133 | 80 | 93 |
| Example 3-6 | 20 | 0.07 | 25 | 0.8 | 4.0 | 1.8 | 3.9 | 0.1 | 0.6 | 45 | 0.0133 | 81 | 92 |
| Example 3-7 | 12 | 0.07 | 25 | 0.5 | 4.0 | 1.8 | 3.9 | 0.1 | 0.6 | 45 | 0.0133 | 78 | 90 |
| Example 3-8 | 40 | 0.07 | 5 | 8 | 4.0 | 1.8 | 3.9 | 0.1 | 0.6 | 45 | 0.0133 | 77 | 95 |
| Example 3-9 | 20 | 0.07 | 15 | 1.3 | 3.3 | 1.8 | 3.2 | 0.1 | 0.6 | 45 | 0.0133 | 76 | 89 |
| Example 3-10 | 20 | 0.07 | 15 | 1.3 | 3.6 | 1.8 | 3.5 | 0.1 | 0.6 | 45 | 0.0133 | 80 | 92 |
| Example 3-11 | 20 | 0.07 | 15 | 1.3 | 3.7 | 1.8 | 3.6 | 0.1 | 0.6 | 45 | 0.0133 | 82 | 96 |
| Example 3-12 | 20 | 0.07 | 15 | 1.3 | 3.8 | 1.8 | 3.7 | 0.1 | 0.6 | 45 | 0.0133 | 83 | 97 |
| Example 3-13 | 20 | 0.07 | 15 | 1.3 | 3.9 | 1.8 | 3.8 | 0.1 | 0.6 | 45 | 0.0133 | 82 | 97 |
| Example 3-14 | 20 | 0.07 | 15 | 1.3 | 4.1 | 1.8 | 4.0 | 0.1 | 0.6 | 45 | 0.0133 | 78 | 92 |
| Example 3-15 | 20 | 0.07 | 15 | 1.3 | 4.6 | 1.8 | 4.5 | 0.1 | 0.6 | 45 | 0.0133 | 76 | 89 |
| Example 3-16 | 20 | 0.07 | 15 | 1.3 | 4.0 | 1.2 | 3.9 | 0.1 | 0.6 | 45 | 0.0133 | 76 | 92 |
| Example 3-17 | 20 | 0.07 | 15 | 1.3 | 4.0 | 2.0 | 3.9 | 0.1 | 0.6 | 45 | 0.0133 | 81 | 94 |
| Example 3-18 | 20 | 0.07 | 25 | 0.8 | 4.0 | 1.8 | 3.9 | 0.07 | 0.6 | 60 | 0.01 | 81 | 95 |
| Example 3-19 | 20 | 0.07 | 25 | 0.8 | 4.0 | 1.8 | 3.9 | 0.1 | 0.6 | 40 | 0.015 | 82 | 96 |
| Example 3-20 | 20 | 0.07 | 25 | 0.8 | 4.0 | 1.8 | 3.9 | 0.2 | 0.6 | 35 | 0.0171 | 83 | 96 |
| Example 3-21 | 20 | 0.07 | 25 | 0.8 | 4.0 | 1.8 | 3.9 | 0.3 | 0.6 | 20 | 0.0300 | 84 | 97 |
| Example 3-22 | 20 | 0.07 | 25 | 0.8 | 4.0 | 1.8 | 3.9 | 0.02 | 0.6 | 65 | 0.0092 | 78 | 90 |
| Example 3-23 | 20 | 0.07 | 25 | 0.8 | 4.0 | 1.8 | 3.9 | 0.4 | 0.6 | 15 | 0.04 | 77 | 91 |
| Example 3-24 | 5 | 0.07 | 50 | 0.1 | 4.0 | 1.8 | 3.9 | 0.1 | 0.6 | 45 | 0.0133 | 73 | 88 |
| Example 3-25 | 20 | 0.07 | 2 | 10 | 4.0 | 1.8 | 3.9 | 0.1 | 0.6 | 45 | 0.0133 | 72 | 89 |
| Example 3-26 | 20 | 0.07 | 25 | 0.8 | 4.0 | 1.8 | 3.9 | 0.6 | 0.6 | 45 | 0.0133 | 70 | 87 |
| Example 3-27 | 20 | 0.07 | 15 | 1.3 | 4.0 | 1.8 | 3.9 | / | / | 45 | / | 70 | 85 |

According to Table 3, it can be seen that when A/E and H−F×G of the positive electrode plate and the thickness of the shell layer and J/K of the hollow microspheres in the electrochemical apparatus are controlled within the ranges of this application, the lithium-ion battery has good low-temperature cycling performance and charge and discharge performance.

According to Example 1-4, Examples 3-1 to 3-8, and Examples 3-24 and 3-25, it can be seen that when the positive electrode plate satisfies: 0.5≤A/E≤8, the lithium-ion battery has relatively good low-temperature cycling performance and charge and discharge performance.

On this basis, according to Example 1-4 and Examples 3-3 and 3-4, it can be seen that when the positive electrode plate satisfies: 1≤A/E≤2, the lithium-ion battery has relatively good high-temperature cycling performance and charge and discharge performance.

According to Example 1-4 and Examples 3-9 to 3-17, it can be seen that when the positive electrode plate satisfies: 3.5≤H−F×G≤4.0, the lithium-ion battery has relatively good low-temperature cycling performance and charge and discharge performance.

On this basis, according to Examples 3-11 to 3-13, it can be seen that when the positive electrode plate satisfies: 3.6≤H−F×G≤3.8, the lithium-ion battery has better low-temperature cycling performance and charge and discharge performance.

According to Example 1-4, Examples 3-18 to 3-23, 3-26, and 3-27, it can be seen that when the separator includes the organic coating, the organic coating includes the hollow microspheres, the hollow microsphere has the shell layer, and the thickness of the shell layer is 0.07 μm-0.3 μm, the lithium-ion battery has relatively good low-temperature cycling performance and charge and discharge performance.

According to Examples 3-1 to 3-23, it can be seen that when the electrochemical apparatus satisfies: 0.01≤J/K≤0.03, the lithium-ion battery has relatively good low-temperature cycling performance and charge and discharge performance.

Although this application has been described with reference to preferred embodiments, various improvements can be made thereto and components can be replaced with equivalents without departing from the scope of this application. In particular, as long as there is no structural conflict, the technical features mentioned in the various embodiments can be combined in any manner. This application is not limited to the specific embodiments disclosed herein, but includes all technical solutions falling within the scope of the claims.

What is claimed is:

1. A conductive carbon black, wherein the conductive carbon black comprises a plurality of carbon black units and pores located between adjacent carbon black units, wherein each carbon black unit comprises holes; and
a bulk density of the conductive carbon black is 0.05 g/cm³-0.1 g/cm³, and a pore volume of the holes is 0.05 cm³/g-0.5 cm³/g.

2. The conductive carbon black according to claim 1, wherein the bulk density of the conductive carbon black is 0.06 g/cm³-0.08 g/cm³, and/or the pore volume of the holes is 0.15 cm³/g-0.3 cm³/g.

3. The conductive carbon black according to claim 1, wherein an equivalent diameter of the holes is 10 nm-45 nm, wherein the equivalent diameter is a diameter of an ideal circular hole that has the same volume or the same specific surface area as the holes.

4. The conductive carbon black according to claim 3, wherein the equivalent diameter of the holes is 15 nm-30 nm.

5. The conductive carbon black according to claim 1, wherein an equivalent diameter of the holes is A (nm), the pore volume of the holes is B (cm³/g), and 100≤A/B≤300, wherein the equivalent diameter is a diameter of an ideal circular hole that has the same volume or the same specific surface area as the holes.

6. The conductive carbon black according to claim 5, wherein 100≤A/B≤200.

7. The conductive carbon black according to claim 1, wherein the conductive carbon black satisfies at least one of the following:
(1) an oil absorption value of the conductive carbon black is 300 mL/100 g-450 mL/100 g;
(2) ID/IG of the conductive carbon black is 0.8-1.3;
(3) a thermal conductivity of the conductive carbon black is 0.1 W/(m·K)-0.5 W/(m·K); or
(4) the conductive carbon black comprises a branched structure formed by stacking the plurality of carbon black units.

8. The conductive carbon black according to claim 7, wherein the conductive carbon black satisfies at least one of the following:
(1) the oil absorption value of the conductive carbon black is 350 mL/100 g-400 mL/100 g;
(2) ID/IG of the conductive carbon black is 1.0-1.2; or
(3) the thermal conductivity of the conductive carbon black is 0.2 W/(m·K)-0.5 W/(m·K).

9. A positive electrode plate, comprising a binder, a positive electrode active material, and a conductive carbon black; wherein the conductive carbon black comprises a plurality of carbon black units and pores located between adjacent carbon black units, wherein each carbon black unit comprises holes; and
a bulk density of the conductive carbon black is 0.05 g/cm³-0.1 g/cm³, and a pore volume of the holes is 0.05 cm³/g-0.5 cm³/g.

10. The positive electrode plate according to claim 9, wherein the bulk density of the conductive carbon black is 0.06 g/cm³-0.08 g/cm³, and/or the pore volume of the holes is 0.15 cm³/g-0.3 cm³/g.

11. The positive electrode plate according to claim 9, wherein an equivalent diameter of the holes is 10 nm-45 nm, wherein the equivalent diameter is a diameter of an ideal circular hole that has the same volume or the same specific surface area as the holes.

12. The positive electrode plate according to claim 11, wherein the equivalent diameter of the holes is 15 nm-30 nm, wherein the equivalent diameter is a diameter of an ideal circular hole that has the same volume or the same specific surface area as the holes.

13. The positive electrode plate according to claim 9, wherein an equivalent diameter of the holes is A (nm), the pore volume of the holes is B (cm³/g), and 100≤A/B≤300, wherein the equivalent diameter is a diameter of an ideal circular hole that has the same volume or the same specific surface area as the holes.

14. The positive electrode plate according to claim 13, wherein 100≤A/B≤200.

15. The positive electrode plate according to claim 9, wherein the positive electrode plate satisfies at least one of the following:
(1) the equivalent diameter of the holes is A (nm), Dᵥ50 of the positive electrode active material is E (μm), wherein the equivalent diameter is a diameter of an ideal circular hole that has the same volume or the same specific surface area as the holes; and
the positive electrode plate satisfies: 0.5≤A/E≤8;
(2) the bulk density of the conductive carbon black is F (g/cm³), a tap density of the positive electrode active material is G (g/cm³), a compacted density of the positive electrode plate is H (g/cm³), and the positive electrode plate satisfies: 3.5≤H−F×G≤4.0; or
(3) an electrolyte retention rate of the positive electrode plate is 10%-26%.

16. The positive electrode plate according to claim 15, wherein the positive electrode plate satisfies: 1≤A/E≤2, and/or the positive electrode plate satisfies: 3.6≤H−F×G≤3.8.

17. An electrochemical apparatus, comprising the positive electrode plate, a negative electrode plate, and a separator, wherein the separator is disposed between the positive electrode plate and the negative electrode plate;
wherein the positive electrode plate comprises a binder, a positive electrode active material, and a conductive carbon black; wherein the conductive carbon black comprises a plurality of carbon black units and pores located between the adjacent carbon black units, wherein the carbon black units comprise holes; and
a bulk density of the conductive carbon black is 0.05 g/cm³-0.1 g/cm³, and a pore volume of the holes is 0.05 cm³/g-0.5 cm³/g.

18. The electrochemical apparatus according to claim 17, wherein the separator comprises an organic coating; the organic coating comprises hollow microspheres; and the hollow microsphere has a shell layer.

19. The electrochemical apparatus according to claim 18, wherein the electrochemical apparatus satisfies at least one of the following:
(1) a thickness of the shell layer is 0.07 μm-0.3 μm; or
(2) the separator further comprises a base film, a particle size of the hollow microspheres is J (μm), a porosity of the base film is K (%), and the electrochemical apparatus satisfies:
$$0.01 \leq J / K \leq 0.03 .$$

20. An electronic apparatus, comprising the electrochemical apparatus according to claim 17.
